(19) United States
(12) Patent Application Publication
(10) Pub. No.: US 2026/0314648 A1
(43) Pub. Date: Oct. 15, 2026

(54) PROCESS FOR PREPARING A PLANT-BASED HOT DOG PRODUCT AND PRODUCT THEREOF

(71) Applicant: Cargill, Incorporated, Wayzata, MN (US)

(72) Inventor: Alicia Esther Lam STUBE, Cottage Grove, MN (US)

(73) Assignee: Cargill, Incorporated, Wayzata, MN (US)

(21) Appl. No.: 19/486,085

(22) PCT Filed: Apr. 29, 2024
(86) PCT No.: PCT/US2024/026740

§ 371 Date: Nov. 20, 2025

Related U.S. Application Data
(60) Provisional application No. 63/504,911, filed on May 30, 2023.

(51) Int. Cl. A23L 35/00; A23L 29/212; A23L 29/238; A23L 29/244; A23L 29/25; A23L 29/256; A23L 29/262; A23L 33/115; A23L 33/185

(52) U.S. Cl. CPC A23L 35/10; A23L 29/212; A23L 29/238; A23L 29/244; A23L 29/25; A23L 29/256; A23L 29/262; A23L 33/115; A23L 33/185

(57) ABSTRACT

A process of preparing a plant-based hot dog product comprises dispersing methylcellulose in liquid plant-based oil to form a methylcellulose/oil liquid dispersion and adding water to the methylcellulose/oil liquid dispersion and mixing to form a methylcellulose/oil/water emulsion. Dry ingredients comprising plant protein, natural gum, starch, and carrageenan are added to the methylcellulose/oil/water emulsion with mixing to form a dough. The dough is dispensed into a casing to form an encased uncooked hot dog that is cooked to form an encased cooked hot dog and chilled to provide a plant-based hot dog product. The casing is optionally removed. Products made by this process are also described.

### CROSS-REFERENCE TO RELATED APPLICATIONS

This application claims the benefit of U.S. Provisional Application No. 63/504,911, filed May 30, 2023, which is incorporated by reference herein in its entirety.

### FIELD

The present invention relates to method of preparing a plant-based hot dog product.

### BACKGROUND

Consumers increasingly desire protein choices that are not derived from animals. Examples of plant-based meat substitute products include the Impossible Burger from Impossible Foods, The Beyond Burger from Beyond Meat, and Ultimate Beefless Burger from Gardein. These and other products are discussed, for example, at https://www.healthline.com/nutrition/vegan-meat-substitutes #section4, which states that the Beyond Burger is made from pea protein, canola oil, coconut oil, potato starch and other ingredients.

United States Patent Application Pub. No. 2013/0243932 describes meat products, including sausages, made by blending a starch, hydrocolloid, and an oil from a vegetable source. The resulting product is stated to be a product with reduced animal fat that maintains the sensory attributes of a full-fat product.

Food products that comprise i) a filling comprising animal, fungal or plant protein and ii) a casing are described in WO2017192445A1. The product comprises (a) a casing made of a mono- or multilayered film of which at least one layer comprises a film-forming synthetic polymer and (b) a filling comprising animal, fungal or plant protein, which method comprises the step of incorporating into the filling a methylcellulose having anhydroglucose units joined by 1-4 linkages wherein hydroxy groups of anhydroglucose units are substituted with methyl groups such that s23/s26 is from 0.10 to 0.24, wherein s23 is the molar fraction of anhydroglucose units wherein only the two hydroxy groups in the 2- and 3-positions of the anhydroglucose unit are substituted with methyl groups and wherein s26 is the molar fraction of anhydroglucose units wherein only the two hydroxy groups in the 2- and 6-positions of the anhydroglucose unit are substituted with methyl groups.

Sausage additives comprising cellulose ether and natural gums are described in United States Patent Application Pub. No. 2015/0351440, wherein an edible composition consisting of (a) natural gum comprising a polysaccharide hydrocolloid (al) containing mannose repeating units; (b) carrageenan; (c) cellulose ether, and optionally (d) water is used in an edible product.

Protein Compositions for Meat Products or Meat Analog Products are described in United States Patent Application Pub. No. 2009/0208633, wherein the method described therein takes an unstructurized protein product with no visible grain or texture and converts it into a structurized, protein product with a definite shape having the consistency of cooked muscle meat. Products made by this method include stuffed meat products such as sausage, salami, hot dogs, and bologna.

A plant-based hot dog is commercially available as the Signature Stadium Dog™ from Field Roast Meat and Cheese Co. The product is described as comprising Water, Canola Oil, Pea Protein, Potato Starch, Methylcellulose, Carrageenan, Vital Wheat Gluten, Brown Rice Protein, Vinegar, Faba Bean Protein, Beet Powder (Color), Sea Salt, Natural Flavor, Cane Sugar, Garlic Powder, Harwood Smoked Sugar, Konjac Flour, Potassium Chloride, Onion Powder, Xanthan Gum, Spices (Black Pepper, Nutmeg), Cherry Powder (To Promote Color Retention), and Paprika. https://fieldroast.com/product/signature-stadium-dog/

Another plant-based hot dog is commercially available as Smart Dogs® from Lightlife, a Canadian company owned by Greenleaf Foods, SPC. The product is described as comprising Water, Soy Protein Isolate, Soy Oil, Evaporated Cane Sugar, Pea Protein Isolate, Tapioca Starch, Potassium Chloride, Dehydrated Garlic, Spice Extract, Fermented Rice Flour, Natural Flavours, Yeast Extract, Natural Smoke Flavour, Xanthan Gum, Guar Gum, Vital Wheat Gluten, Vitamin & Mineral Blend (Niacinamide [Vitamin B3], Ferric Orthophosphate, Zinc Oxide, D-Calcium Pantothenate, Pyridoxine Hydrochloride [Vitamin B6], Thiamine Hydrochloride [Vitamin B1], Riboflavin [Vitamin B2], and Cyanocobalamin [Vitamin B12]. https://lightlife.com/en-ca/product/smart-dogs/SUMMARY

Plant-based that are modeled after meat-containing products, such as hot dogs, often fall short of the desired organoleptic experience, because they lack one or more of the visual and textural characteristics of the target animal meat-containing product experience. One can make a plant-based product by use of a plant-based protein with added plant-based oil to try to make a product modeled after a meat product having generally the same protein/oil content, but the texture of such a product is lacking.

Meat analogue products, which for purposes of the present discussion are food products that mimic meat but which contain no animal meat ingredients, are particularly difficult to prepare.

Specifically, the cooking behavior, mouthfeel, moisture, and presentation of the desired protein/oil balance in plant-based products is challenging because vegetable-sourced oils are normally lost from the product during cooking. It additionally is challenging to achieve the desired consistency of the plant-based product while using only non-animal-sourced components without incorporating a number of additives that present a long ingredient list with names that sound artificial and undesirable to the average consumer.

A particularly challenging category of plant-based product to produce is the hot dog, which is a category of sausage that is a cooked emulsion sausage comprising a filling that has been comminuted to a fine paste, prepared by a process that includes cooking and distributed with the recommendation that the product be heated again for consumption as a heated food product. Food products of this category is referred to by a number of names, such a hot dog, wiener (including Vienna sausages), frankfurter or frank. While aficionados of this food product may have strong opinions that, for example, a frankfurter is a different product from a hot dog, there is no definitive definition that would distinguish these products by name. For purposes of the present disclosure, a sausage that is a cooked emulsion sausage comprising a filling that has been comminuted to a fine paste, prepared by a process that includes cooking and distributed with the recommendation that the product be heated again for consumption as a heated food product will generically be referred to as a “hot dog.” In an aspect, hot dogs as described herein include such sausages provided without a casing, or provided in a casing that is a natural casing or provided in a casing that is an artificial casing.

Most commercial plant-based hot dogs rely on vital wheat gluten to provide firmness and texture to the hot dog. To create a low gluten content version or to create a gluten-free version of a hot dog product, a different approach must be used to provide both a firm hot bite, to provide a desirable eating experience, and also maintain shape and firmness when cold, so that the hot dog doesn't lose its shape during storage and transport. Plant-based hot dogs can also tend to be dry in texture and lack the fattiness/juiciness of their meat-based counterparts. Simply increasing the amount of fat in the formula without achieving proper emulsification will result in separation and fatting out during the initial cook process and will produce a messy, oily hot dog with undesirable texture. It has been found that plant-based hot dogs having excellent organoleptic characteristics may be prepared when the composition is selected to comprise a proper balance of functional ingredients to support emulsification as well as hot and cold firmness and moisture balance, and when the hot dog is prepared by a process that achieves the desired value from those functional ingredients and achieves sufficient emulsification for the formula to remain stable through an initial cook cycle, freeze-thaw, and secondary reheating. The thus prepared plant-based hot dog provides an eating experience that is very close to that of a meat-based hot dog, and exhibits much improved firmness and juiciness characteristics over alternative plant-based hot dog products. In an aspect, the thus prepared plant-based hot dog does not rely on gluten to provide texture properties.

In an aspect, it has been discovered that management of moisture is a very important part of these products as there are many functional ingredients, all of which are water hungry and must be properly hydrated to perform their functions. There is only a limited amount of water available in a formula and order of hydration is critical in determining end product performance. Traditional processing techniques have prioritized hydrating the plant proteins or split the hydration between the plant proteins and a hydrocolloid emulsion.

It has been discovered that superior organoleptic properties, and in particular texture and mouthfeel properties, are obtained by addition of ingredients in a sequence and under conditions wherein the methylcellulose component is first hydrated under controlled conditions to provide a desired degree of hydration of the methylcellulose component with lesser hydration of other functional ingredients (in particular hydrocolloid and protein components in the product). To control the hydration of the methylcellulose component, methylcellulose is dispersed in liquid plant-based oil to form a methylcellulose/oil liquid dispersion. Then water is added at a temperature suitable for hydration of the methylcellulose, e.g., about 32° F. to about 40° F., to the methylcellulose/oil liquid dispersion and mixed to form a methylcellulose/oil/water emulsion. Since the methylcellulose is dispersed in the oil at this state of the process, hydration of the methylcellulose is controlled.

Dry ingredients of the hot dog product comprising plant protein, natural gum, starch, and carrageenan, are then added to the methylcellulose/oil/water emulsion with mixing to form a dough. The dough is optionally cooled to a temperature of from about 35° F. to about 50° F., and a vacuum is applied to the dough to remove air pockets. The dough is then dispensed into a casing to form an encased uncooked hot dog. The encased uncooked hot dog is cooked to an internal temperature of about 185° F. to form an encased cooked hot dog, which is chilled to an internal temperature of about 45° F. or less to provide a plant-based hot dog product. In an aspect, the casing is removed to form a non-encased plant-based hot dog product.

While not being bound by theory, it is believed that formation of the emulsion with methylcellulose prior to addition of substantial amounts of other the dry ingredients permits the methylcellulose to be more fully hydrated than if the methylcellulose were hydrated when in mixture with all of the dry ingredients of the hot dog composition. It is believed that when all of the dry ingredients are hydrated together, the ingredients compete for water, so that less water will be available for methylcellulose to hydrate. It has been found that hot dogs prepared using the present process conditions achieve superior hot gelling firmness, creating a firmer, more desirable texture than would be obtained if the methylcellulose and proteins were hydrated together. Moreover, it has been found that by effective blending of the composition after addition of all of the ingredients to form the dough, the emulsion is stable through preliminary cooking and processing and the final plant-based hot dog product may exhibit an excellent, non-gritty texture.

It additionally has been found that hydration of the methylcellulose prior to addition of the methylcellulose to the oil and formation of the emulsion leads to inadequate final product characteristics when ordinary mixing techniques are employed. It has been discovered that methylcellulose is hydrated before emulsion formation, the emulsion tends to be unstable, the final product appearance is less than desirable because it exhibits discontinuities (“fish eyes”) and the final product tends to undesirably have an oily appearance and mouthfeel. While in theory it is possible to hydrate the methylcellulose before mixing with the oil, the mixing would have to be carried out under high shear to avoid the problems listed above. However, high shear mixing leads to more problems, such as air incorporation, that would require the use of additional steps and equipment to avoid the newly introduced problems.

### BRIEF DESCRIPTION OF THE DRAWING

FIG. 1 is a graph showing the firmness of the hot dogs of Examples 1~4 measured under the Heated Hot Dog Product Firmness Test.

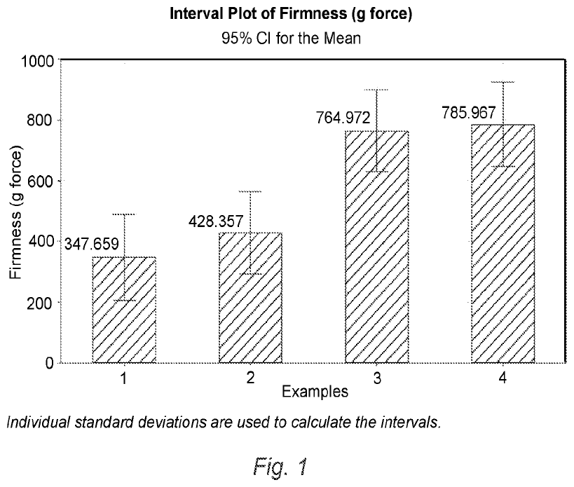

### DETAILED DESCRIPTION

The aspects of the present invention described below are not intended to be exhaustive or to limit the invention to the precise forms disclosed in the following detailed description. Rather a purpose of the aspects chosen and described is by way of illustration or example, so that the appreciation and understanding by others skilled in the art of the general principles and practices of the present invention can be facilitated.

It has been found that incorporation of methylcellulose in the plant-based product as presently described provides a substantial benefit in the product in its uncooked state, after having been cooked once and is in its chilled state, and after the product is cooked for consumption. Methylcellulose has been found to exhibit excellent emulsifying performance in the raw product to provide superior product mixing, stabilization, and handling properties. Once the product is cooked, the cold, uncooked plant-based product exhibits excellent shaping and handling characteristics.

It has been found that plant-based products as presently described are much firmer when hot than when cold. While not being bound by theory, it is believed that methylcellulose exhibits at least partially thermo-reversible texture enhancing properties in the context of the present plant-based product, so that the plant-based product exhibits enhanced firmness characteristics after the initial heating, with retention of at least some firmness characteristics upon chilling. Additionally, plant-based products as presently described comprising methylcellulose have been found to exhibit superior, firm texture properties during the final cooking process immediately before consumption, and while the product is hot as compared to like products not comprising methylcellulose. It has been found that the plant-based product comprising methylcellulose as provided in the present method exhibits superior final product texture properties when the product consumed as a heated food product, e.g., at a temperature of from about 145° F. to about 180° F.

In an aspect, the methylcellulose is a food grade methylcellulose yielding a viscosity of from about 8000 to about 160,000 cP at 2% in water @20° C. In an aspect, the methylcellulose is a food grade methylcellulose having a viscosity of from about 37500 to about 100,000 cP at 2% in water @20° C. In an aspect, the methylcellulose is a food grade methylcellulose having a viscosity of from about 80000 to about 160,000 cP at 2% in water @20° C. In an aspect, the methylcellulose is a food grade methylcellulose having a methoxyl content of from about 25% to about 32%. Suitable methylcellulose products are commercially available, such as Dow Wellence Vege Form 183 or Shin Etsu Metolose MCE-100TS.

In an aspect, the methylcellulose is present in the dough in an amount of from about 0.5 wt % to about 4 wt %. In an aspect, the methylcellulose is present in the dough in an amount of from about 1 wt % to about 3 wt %. In an aspect, the methylcellulose is present in the dough in an amount of from about 1.5 wt % to about 2 wt %.

In an aspect, the plant-based oil is selected from the group consisting of avocado, canola, coconut, cocoa, corn, cottonseed, flax, olive, palm, palm kernel, peanut, rapeseed, safflower, soya, and sunflower and mixtures thereof. In an aspect, the plant-based oil is selected from the group consisting of sunflower oil, coconut oil, and mixtures thereof. In an aspect, the plant-based oil is selected from unsaturated plant-based oils. In an aspect, the plant-based oil is selected from poly-unsaturated plant-based oils.

In an aspect, the plant-based oil is present in the dough in an amount of from about 5 wt % to about 25 wt %. In an aspect, the plant-based oil is present in the dough in an amount of from about 8 wt % to about 23 wt %. In an aspect, the plant-based oil is present in the dough in an amount of from about 10 wt % to about 20 wt %.

In an aspect, the plant-based oil comprises a mixture of sunflower oil and coconut oil at a sunflower oil to coconut oil ratio of from about 0.35 to about 0.65. In an aspect, the plant-based oil comprises a mixture of sunflower oil and coconut oil at a sunflower oil to coconut oil ratio of from about 0.4 to about 0.6. In an aspect, the plant-based oil comprises a mixture of sunflower oil and coconut oil at a sunflower oil to coconut oil ratio of from about 0.45 to about 0.55.

In an aspect, the oil used is a mixture of oils wherein one oil is a liquid at the processing temperature (e.g., room temperature of 23° C.) and the second oil is a solid at the processing temperature, wherein the liquid oil and the solid oil are mixed at relative amounts and under conditions such that the solid oil blends with the liquid oil to provide an oil blend that is liquid at the processing temperature.

In an aspect, the oil may be heated so that it is in the liquid stage when mixed with the methylcellulose. In an aspect, the oil is at a temperature of from about 35° F. to about 110° F., such as from about 35° F. to about 70° F., when mixed with the methylcellulose. In an aspect, the oil is at a temperature of from about 65° F. to about 110° F., such as from about 85° F. to about 110° F., when mixed with the methylcellulose.

As noted above, the water is added to the methylcellulose/oil liquid dispersion at a water temperature appropriate for the hydration of the particular methylcellulose that is selected. In an aspect, the methylcellulose is selected to be hydrated at a temperature of from about 32° F. to about 40° F. It has been found that selection of a methylcellulose that is designed to be hydrated at a temperature of from about 32° F. to about 40° F. advantageously promotes firmness of the final hot dog product when reheated.

Water is added to the methylcellulose/oil liquid dispersion in an amount sufficient to support an emulsion. In an aspect, the water is added to the methylcellulose/oil liquid dispersion in a methylcellulose:water ratio of from about 1:25 to about 1:40. In an aspect, the methylcellulose/oil liquid dispersion is at a temperature of from about 35° F. to about 110° F. when mixed with the water. In an aspect, the methylcellulose/oil liquid dispersion is at a temperature of from about 35° F. to about 100° F. when mixed with the water. In an aspect, the methylcellulose/oil liquid dispersion is at a temperature of from about 35° F. to about 70° F. when mixed with the water. In an aspect, the methylcellulose/oil liquid dispersion is at a temperature of from about 35° F. to about 60° F. when mixed with the water. In an aspect, the methylcellulose/oil liquid dispersion is at a temperature of from about 35° F. to about 50° F. when mixed with the water. In an aspect, the methylcellulose/oil liquid dispersion is at a temperature of from about 35° F. to about 40° F. when mixed with the water.

In an aspect, the emulsion is formed at a chilled temperature to promote firmness of the final hot dog product.

Any suitable mixing apparatus with sufficient shear to prepare the emulsion, such as a blender, may be used to mix the water with the methylcellulose/oil liquid dispersion. In an aspect, the mixing apparatus may comprise a cooling jacket or other cooling mechanism to reduce the temperature of the composition during mixing.

In an aspect, after formation of the emulsion, the emulsion is cooled to or maintained at a temperature of about 40° F. or less. In an aspect, after formation of the emulsion, the emulsion is cooled to or maintained at a temperature of from about 32° F. to about 40° F.

After formation of the emulsion, the dry ingredients of the hot dog product, comprising plant protein, natural gum, starch, and carrageenan, are added to the emulsion to form the dough. In an aspect, the dry ingredients of the hot dog product are mixed together to form a dry blend and added together to the emulsion to form a dough. In an aspect, the dry ingredients of the hot dog product are added sequentially to the emulsion, or are added in combinations of two or more dry ingredients to the emulsion to form a dough. These additional functional ingredients are added to improve the cold set of the hot dog after initial cooking and to enhance the organoleptic characteristics of the hot dog product, including enhanced firmness in the cold, uncooked plant-based product prior to reheating for good shaping and handling characteristics, and product integrity properties when the plant-based product is re-heated for consumption. In particular, it has been found that a hot dog product prepared comprising methylcellulose but not containing plant protein, natural gum, starch, and carrageenan as described herein is quite malleable when cold (due to the thermal reversible properties of the methylcellulose), even after an initial cook, and may be subject to deformation when stripping the casing or even removing from the packaging. Thus, it has been found that incorporation of plant protein, natural gum, starch, and carrageenan as described herein together with methylcellulose work together as a complementary system that provides a hot dog product exhibiting desirable cold and hot texture and consistency characteristics.

Plant proteins, such as pea protein, provide the protein foundation of the hot dog product, and advantageously helps to create more of the chew and resistance characteristics of a “meat-like” product vs. a smooth gelled texture that cleaves readily to the bite. Additionally, plant proteins are incorporated in the hot dog as described herein as providing a desirable protein nutrient that is particularly beneficial in a plant-based hot dog product intended to replace meat-based hot dog products.

In an aspect, the plant protein used as in the present process may be selected from alfalfa, algal, bean, broad bean, chia, clover, pea (including yellow pea), chickpea, cow pea, earth pea, sweet pea, pigeon pea, kidney bean, mung bean, navy bean, soy, legume, lentil, lupin, mesquite, cocoa, carob, nut, peanut, almond, potato, cereal, maize, rice, sorghum, millet, oat, buckwheat, fonio, quinoa, hemp, fungal, seaweed protein or mixtures thereof. In an aspect, the plant protein used in the present process may be selected from soy or pea protein. In an aspect, the plant protein used in the present process is pea protein.

In an aspect, the plant protein used in the present process is provided from a plant protein concentrate composition (i.e., the source composition contains not less than 55% protein on a moisture free basis). In an aspect, the plant protein used in the present process is provided from a plant protein isolate composition (i.e., the source composition contains not less than 85% protein on a moisture free basis).

In an aspect, the plant protein used in the present process is a powdered plant protein having a particle size range of from about 20 to about 300 μm.

In an aspect, the plant protein is present in the dough in an amount of from about 5 wt % to about 25 wt %. In an aspect, the plant protein is present in the dough in an amount of from about wt % to about 20 wt %. In an aspect, the plant protein is present in the dough in an amount of from about 8 wt % to about 15 wt %.

In an aspect, the plant protein is present in the dough does not comprise a mechanically textured protein component (i.e., plant protein that has been textured by a mechanical process such as extrusion, shear cell technology, and the like).

In an aspect, the plant protein composition comprises a natural gum comprising a polysaccharide hydrocolloid containing mannose repeating units. The term “natural gum” as used herein may be a single gum or a mixture of various types of natural gums. It has been found that natural gums advantageously contribute to providing a hot dog with a texture that is more meat-like and and balances out the brittle gel characteristics associated with the firmness-contributing ingredients incorporated in the present hot dog product.

In an aspect, the natural gum is selected from glucomannan, galactomannan, and mixtures thereof. In an aspect, the natural gum is glucomannan. In an aspect, the natural gum is a vegetable gum. In an aspect, the natural gum is selected from konjac gum, fenugreek gum, guar gum, tara gum, locust bean gum (carob gum), or a mixture thereof. In an aspect the natural gum is selected from konjac gum, locust bean gum or a mixture thereof. In an aspect the natural gum is konjac gum.

It is noted that the natural gum may contain water in varying amounts depending on the method of refining.

In an aspect, the natural gum is present in the dough in an amount of from about 0.1 wt % to about 3 wt %. In an aspect, the natural gum is present in the dough in an amount of from about 0.3 wt % to about 2 wt %; %. In an aspect, the natural gum is present in the dough in an amount of from about 0.3 wt % to about 1 wt %.

Starch is incorporated in the hot dog as described herein, and has been found to contribute to providing a hot dog with a texture that is more meat-like and balances out the brittle gel characteristics associated with the firmness-contributing ingredients incorporated in the present hot dog product.

In an aspect, the starch is selected from the group consisting maize starch, potato starch, sweet potato starch, wheat starch, rice starch, tapioca starch, sorghum starch, sago starch, and mixtures thereof.

In an aspect, the starch is a modified starch selected from a starch octenylsuccinate, a hydroxypropyl distarch phosphate, and mixtures thereof. The modified starch may be produced from a starch selected from the group consisting maize starch, potato starch, sweet potato starch, wheat starch, rice starch, tapioca starch, sorghum starch, sago starch, and mixtures thereof.

In an aspect, the modified starch is a hydroxypropyl distarch phosphate made from waxy maize, such as PolarTex 06732 from Cargill, Incorporated.

In an aspect, the modified starch is a n-OSA substituted dextrin made from waxy maize starch, such as EmCap 06376 from Cargill, Incorporated. In an aspect, the starch is an acid thinned n-OSA substituted dextrin made from waxy maize starch, such as EmCap 06375 from Cargill, Incorporated.

In an aspect, the modified starch is a n-OSA substituted and oxidized tapioca starch, such as C*DeliTex 75320 from Cargill, Incorporated. Examples of n-octenyl succinilated starches are disclosed in U.S. Pat. No. 6,235,894, the disclosure of which is incorporated herein by reference.

It has been found that incorporation of the starch in the plant-based product as presently described provides a substantial benefit in processing, and additionally in mouthfeel of the final product. In an aspect, it has been found that incorporation of a modified starch in the plant-based product as presently described provides a substantial benefit in processing, and additionally in mouthfeel of the final product. In an aspect, the plant-based product as described herein provides a positive moisture perception in mouth, which is a positive attribute associated with meat.

In an aspect, the starch is present in the dough in an amount of from about 0.2 wt % to about 3 wt %, for example from about 0.3 wt % to about 2.5 wt % or from about 0.5 wt % to about 1.5 wt %.

Carrageenan is a generic term for a family of linear sulfated polysaccharides that are extracted from seaweeds such as for example Gigartina and Chondrus crispus (Irish Moss). All carrageenans are polysaccharides made of repeating units of galactose and 3,6-anhydrogalactose (3,6-AG), both sulfated and nonsulfated. The units are joined by alternating 1α→3 and 1β→4 glycosidic linkages. The three main commercial classes of carrageenan are k-carrageenan, t-carrageenan, and λ-carrageenan; however additional types of carrageenan exist. In an aspect, any type of carrageenan may be used, either alone or in admixtures with at least one other type. In an aspect, the carrageenan is K-carrageenan.

In an aspect, the carrageenan is present in the dough in an amount of from about 0.2 wt % to about 3 wt %. In an aspect, the carrageenan is present in the dough in an amount of from about 0.3 wt % to about 2 wt %. In an aspect, the carrageenan is present in the dough in an amount of from about 0.5 wt % to about 1.5 wt %.

It has been found that carrageenan advantageously contributes to providing the present hot dog with advantageous brittle gel and firmness characteristics corresponding to the desired organoleptic experience expected by the consumer when eating a hot dog.

In an aspect, the dry ingredients comprise an additional ingredient selected from flavorants, seasonings, colorants, sugar, salt, preservatives (i.e., an ingredient to prevent or retard micro growth and/or spoilage), vitamins, and minerals. In an aspect, certain added ingredients, such as flavorants, seasonings and colorants may include gluten as formulated. However, the amount of gluten that could be included in added ingredients would not be present in an amount sufficient to contribute materially to the firmness and texture of the hot dog. If wheat gluten is present, it is desirably less than 5%, preferably less than 3%, more preferably less than 2% or less than 1% of the weight of the dough. If so desired, wheat gluten may make up 0.1% to 5%, of the weight of the dough, such as 0.1% to 3%, 0.1% to 2%, 1% to 3%, or 1% to 2% of the weight of the dough.

In an aspect, the dry ingredients comprise seasonings selected from paprika, garlic, cayenne, chili pepper, black pepper, nutmeg, allspice, celery seed, coriander, and myrtle berries.

In an aspect, the plant-based hot dog product is formulated with flavor ingredients selected to mimic the flavor of a meat-based hot dog product. In an aspect, the plant-based hot dog product is formulated with flavor ingredients selected to mimic the flavor of beef. In an aspect, the plant-based hot dog product is formulated with flavor ingredients selected to mimic the flavor of pork. In an aspect, the plant-based hot dog product is formulated with flavor ingredients selected to mimic the flavor of chicken. In an aspect, the plant-based hot dog product is formulated with flavor ingredients selected to mimic the flavor of turkey.

In an aspect, the plant-based hot dog product is formulated with flavor ingredients selected to provide a flavor profile that is not a meat flavor.

In an aspect, the additional ingredients may be added to the oil phase and dispersed with the methylcellulose. In an aspect, the additional ingredients that are oil soluble flavors/colors may be added to the oil prior to addition of the water. In an aspect, the additional ingredients that are liquid water-soluble flavors/colors may be added to the water prior to addition to the oil and formation of the emulsion.

Any suitable mixing apparatus may be used to form the dough. In an aspect, the mixing apparatus is a blender. In an aspect, the mixing apparatus uses an impeller such as a paddle blender.

In an aspect, the mixing apparatus is a food chopper. For purposes of the present description, a food chopper is a food cutter having a flat surface for receiving food to be cut, and one or more vertically movable cutting blades configured to effectively mix the dough.

In an aspect, the mixing apparatus is a bowl chopper. For purposes of the present description, a bowl chopper is a food cutter having a rotary bowl for receiving food to be cut, and one or more vertically oriented blades (also described as “knives” in the art) attached to a horizontally oriented rotary knife shaft. The rotary bowl rotates around a vertical axis, and the blades cut by rotation of the horizontally oriented rotary knife shaft. The blades are aligned relative to the internal wall or walls of the bowl such that they may chop and mix the food within the bowl. While the lateral position of the rotary knife shaft is substantially stationary, the bowl and the contents therein rotate relative to the blades whereby the contents are continuously moved against the blades as the bowl is rotating. In an aspect, the blades may be run in only a forward direction, or in an aspect run in both a forward direction and a reverse direction. Bowl choppers are commercially available, and are described, for example, in U.S. Pat. No. 5,996,917, the disclosure of which is incorporated herein by reference.

In an aspect, the mixing apparatus is a food processor. For purposes of the present description, a food processor is a food cutter having a food container for receiving food to be cut that is fitted with a hub configured to be coupled to a drive shaft of the food processor. One or more blades are rotatably coupled to the hub. In the case of the food processor, the blades are horizontally oriented, and the hub and drive shaft are generally vertically oriented. In an aspect, the blades may be run in only a forward direction, or in an aspect run in both a forward direction and a reverse direction. Food processors are commercially available, and are described, for example, in U.S. Pat. No. 7,054,348, the disclosure of which is incorporated herein by reference.

In an aspect, an acid is additionally incorporated during mixing of the dough in an amount sufficient to provide a dough having a pH of from about 5.5 to about 7.5. In an aspect, an acid is additionally incorporated during mixing of the dough in an amount sufficient to provide a dough having a pH of from about 6 to about 7.5. In an aspect, an acid is additionally incorporated during mixing of the dough in an amount sufficient to provide a dough having a pH of from about 6 to about 7. In an aspect, an acid is additionally incorporated during mixing of the dough in an amount sufficient to provide a dough having a pH of from about 6 to about 6.5. The acid may be any acid suitable to be used in food. In an aspect, the acid is selected from the group consisting of citric acid, lactic acid, acetic acid, or mixtures thereof. In an aspect, the acid is selected from the group consisting of citric acid, lactic acid, acetic acid, and mixtures thereof. In an aspect, the acid is provided as vinegar. It has been found that addition of acid to the indicated pH range provides benefits in shelf life, texture and flavor of the final product. In particular, the use of vinegar as the acid source is desirable in providing a component of the flavor profile desirable in hot dog products.

In an aspect, after being mixed, but prior to being formed into a hot dog product, the dough has a firmness consistency of from about 850 grams of force (g-force) to about 2000 g-force as determined by the Raw Dough Firmness Test described below.

In an aspect, after being mixed the dough additional food particles are incorporated therein, such as cheese, pepper chunks, and the like.

After mixing, the dough is optionally cooled to a temperature of from about 35° F. to about 50° F. prior to dispensing into the casing.

Prior dispensing into the casing, a vacuum is applied to the dough to “degas” the dough in an amount sufficient to remove undesired air pockets or bubbles. Any suitable vacuum system may be used to degas the dough to remove air pockets in the dough.

As noted above, the dough is dispensed into a casing to form an encased uncooked hot dog. The dough may be dispensed into the casing by any suitable dispensing mechanism, such as by piping the dough into the casing or otherwise stuffing the casing with the dough using conventional sausage stuffing equipment.

In an aspect, the casing is an artificial casing. In an aspect, the casing is an artificial casing manufactured from natural materials. In an aspect, the casing is an artificial casing made of natural materials selected from cellulosic casings and collagen casings. In an aspect, the casing is an artificial casing made of natural materials that is permeable to gases, smoke and water vapor. In an aspect, the artificial casings made of natural materials are edible, and therefore do not need to be removed from the encased cooked hot dog, and therefore may be provided to the consumer in the form of an encased plant-based hot dog product.

In an aspect, the casing is an artificial casing manufactured from synthetic substances. In an aspect, the casing is an artificial casing manufactured from thermoplastic materials (“synthetic casings”). In an aspect, the synthetic casings are mechanically strong, relatively heat resistant, impermeable to smoke, gases and water vapor. Synthetic casings are particularly useful for sausages with larger caliber, sausages where water vapor losses are not wanted, sausages to be cooked at relatively high temperatures and sausages with long shelf life and good preservation of taste and flavor. Suitable materials are polyamide (PA), polyethylene (PE), polypropylene (PP), polyvinylidenchloride (PVDC) and polyester (PET). The above-mentioned categorization of casings is disclosed in the FAO (Food and Agriculture Organization of the United Nations) Corporate Document Repository under the Title “Meat processing technology for small and medium-scale producers” under the keyword “Casings”.

In an aspect, the casing is permeable to water vapor.

In an aspect, the casing is made of a mono- or multilayered film of which at least one layer comprises a film-forming synthetic polymer. Such casings for processed meat products are well known in the art. In an aspect, the casings, such as sausage casings, are typically made of 1-5 layered films. In an aspect, the film-forming polymer of at least one film layer is a thermoplastic synthetic polymer, which may be a polyamide, polyethylene, polypropylene, polyvinylidene chloride or polyester. In an aspect, the film layer can contain adjuvants, such as plasticizers, colorants or other known additives, but they should not substantially affect the film-forming properties of the synthetic polymer and other properties that are provided by the synthetic polymer to the casing, such as its known impermeability to smoke, water vapor or other gases. In an aspect, the water vapor impermeable casings have water vapor permeability of not more than 10 g/m²·d, or not more than 9 g/m²·d, measured according to DIN 53122 at 38° C. and 100% relative humidity. A wide variety of water vapor impermeable casings are disclosed in the art, e.g., in European Patent Application Nos. EP 0 603 676 and EP 1 817 962 and in International Patent Application Nos. WO 2005/11323 and WO 2017/192445; the disclosures of which are incorporated herein by reference with respect to the discussions regarding the preparation, identity and use of casings provided therein.

In an aspect, when the casing is filled, the casing has a generally cylindrical shape, but other shapes may also be suitable. In an aspect, the encased uncooked hot dog, i.e., its casing when filled, has a diameter of at least about 1 cm; or has a diameter of at least about 3 cm or has a diameter of at least 5 cm. In an aspect, the encased uncooked hot dog has a diameter of up to 30 cm. In an aspect, the encased uncooked hot dog has a diameter of up to 15 cm. In an aspect, the encased uncooked hot dog has a diameter of up to 8 cm. In an aspect, the encased uncooked hot dog has a diameter of from about 1 cm to about 5 cm. In an aspect, the encased uncooked hot dog has a diameter of from about 1 cm to about 3 cm. In an aspect, the encased uncooked hot dog has a diameter of from about 1 cm to about 2.5 cm.

In an aspect, the encased uncooked hot dog has a length of from about 3 cm to about 90 cm. In an aspect, the encased uncooked hot dog has a length of from about 3 cm to about 60 cm. In an aspect, the encased uncooked hot dog has a length of from about 3 cm to about 12 cm. In an aspect, the encased uncooked hot dog has a length of from about 10 cm to about 35 cm. In an aspect, the encased uncooked hot dog has a length of from about 10 cm to about 25 cm. In an aspect, the encased uncooked hot dog has a length of from about 10 cm to about 20 cm.

The thus prepared encased uncooked hot dog is then cooked to an internal temperature of at least about 185° F. to form an encased cooked hot dog. In an aspect, the encased uncooked hot dog is cooked to an internal temperature of at least about 190° F. to form an encased cooked hot dog. In an aspect, the encased uncooked hot dog is cooked to an internal temperature of at least about 195° F. to form an encased cooked hot dog.

In an aspect, the casing is permeable to water vapor, and the encased uncooked hot dog is then cooked in a steam oven to an internal temperature of at least about 185° F. to form an encased cooked hot dog. In an aspect, the casing is permeable to water vapor, and the encased uncooked hot dog is then cooked in a steam oven to an internal temperature of at least about 190° F. to form an encased cooked hot dog. In an aspect, the casing is permeable to water vapor, and the encased uncooked hot dog is then cooked in a steam oven to an internal temperature of at least about 195° F. to form an encased cooked hot dog. It has been found that cooking of an encased uncooked hot dog having a water vapor permeable casing in a steam oven is particularly effective in achieving the desired texture properties of the final cooked product. While not being bound by theory, it is believed that cooking of the described encased uncooked hot dog in the presence of steam facilitates a desired degree of gelling of the protein and additional ingredients in the hot dog, thereby affording a final plant-based hot dog product exhibiting excellent texture and other organoleptic properties.

The thus prepared encased cooked hot dog is chilled to an internal temperature of from about 45° F. or less. In an aspect, after the chilling of the encased cooked hot dog, the casing is removed by a suitable process to provide a non-encased plant-based hot dog product. It has been found that chilling the hot dog facilitates removal of the casing from the cooked hot dog. While not being bound by theory, it is believed that chilling enhances the textural difference and/or reduces the adhesion of the cooked hot dog and the casing so that removal of the casing can be carried out without damage to the surface of the cooked hot dog. In an aspect, encased cooked hot dog is chilled to an internal temperature of about 40° F. or less. In an aspect, encased cooked hot dog is chilled to an internal temperature of about 36° F. or less.

In an aspect, a non-encased plant-based hot dog product prior to reheating has a Cold Firmness Consistency of from about 250 g-force to about 500 g-force as determined by the Cold Hot Dog Product Firmness Test described below.

In an aspect, a non-encased plant-based hot dog product after reheating to a temperature of 165° F. has a Hot Firmness Consistency of from about 400 g-force to about 1100 g-force as determined by the Heated Hot Dog Product Firmness Test described below. Preferably, such a reheated non-encased plant-based hot dog product has a Hot Firmness Consistency of from about 600 g-force to about 1100 g-force or from about 800 g-force to about 1100 g-force, also as determined by the Heated Hot Dog Product Firmness Test.

In an aspect, the cooked plant-based product is provided in overwrapped trays. This package type features air permeable overwrap with plant-based product placed on an absorbent pad in a foam or plastic tray, packaging. In an aspect, the plant-based product is provided in a case ready tray, wherein the plant-based product is packaged and sealed at the manufacturing facility in a plastic-lidded package. In an aspect, the cooked plant-based product is provided in a wax-lined cardboard box. In an aspect, the cooked plant-based product is provided in a sealed moisture vapor impermeable bag. In an aspect, the cooked plant-based product is provided in a sealed inert gas impermeable bag. In an aspect, the cooked plant-based product is provided in a sealed inert gas impermeable bag having a substantially oxygen-free atmosphere.

In an aspect, the customer purchasing the plant-based product may be a home consumer. In an aspect, the customer purchasing the plant-based product may be institutional customers, such as restaurants and food service providers (such as work or school cafeterias, hospitals, and the like). The plant-based product may be reheated and presented essentially as provided to the customer, or may be reheated and incorporated into a final food product assembled by the customer.

In an aspect, the plant-based product may be reheated for consumption by any appropriate method, such as by smoking, boiling, frying, roasting baking, deep frying, grilling or microwaving, for a suitable time and temperature to provide a cooked plant-based product.

In an aspect, the plant-based product is substantially free of ingredients selected from the group consisting of one or more of: monosodium glutamate, artificial food coloring, added preservatives, sodium nitrite, sodium benzoate, sulfites, propyl gallate, high-fructose corn syrup, and trans fat. Exclusion of one or more of these ingredients from the plant-based product is beneficial in reducing the number of additives incorporated into the product, advantageously reducing cost and also simplifying the ingredient list that must be reported to customers. It has been found to be desirable in the food industry to provide products having a reduced number of ingredients or in an aspect a “clean label” panel of ingredients where possible, which is valued by many consumers.

In an aspect, the plant-based product is prepared by a process that does not include extrusion of any composition through a die under heat and pressure. It has been found that formation of the plant-based product in a process as described herein without a die extrusion process step greatly simplifies the process and advantageously provides a plant-based hot dog product that exhibits the desired texture characteristics of a hot dog.

In an aspect, the present hot dog product does not contain soy allergens.

In an aspect, the present hot dog product does not contain animal sourced ingredients other than animal-sourced casing ingredients, such as collagen casing ingredients. In an aspect, the present hot dog product does not contain animal sourced ingredients other than animal-sourced flavorants. In an aspect, the present hot dog product does not contain animal sourced ingredients other than animal-sourced casing ingredients and animal-sourced flavorants. In an aspect, the present hot dog product does not contain animal sourced ingredients.

### Test Methodologies

The texture of plant-based hot dog products is evaluated at different stages of product preparation by evaluating texture of the product on a TA.XT Plus-Texture analyzer apparatus (Stable Micro Systems) fitted with a 50 kg load cell under the following sample preparation and instrument setting parameters:

### Raw Dough Firmness Test

Raw dough is prepared and held overnight in a refrigerator. Cold dough at a temperature of 40-45 F is dispensed into 2 ounce sample cups and levelled off at the top of the cup. The Texture Analyzer Apparatus is fitted with a probe that is a TA-11, Cylinder 1″ diameter AOAC cylinder.

Texture Analyzer Apparatus instrument parameters are set as follows:

| Pre-test speed | 1.00 | mm/sec |
|---|---|---|
| Test speed | 5.00 | mm/sec |
| Post-test speed | 10.00 | mm/sec |
| Target, distance | 15 | mm |
| Time | 5 | sec |
| Trigger | Auto (Force) | |
| Trigger force | 5.0 | g |

This is referred to herein as the “Raw Dough Firmness Test.” Graphs were analyzed for peak positive force, which was recorded as firmness with units “g-force.”

### Cold Hot Dog Product Firmness Test

A non-encased plant-based hot dog product (i.e., prior to reheating for consumption) is prepared and held overnight in a refrigerator. The cold hot dog product at a temperature of 40-45 F is prepared for testing by trimming ends to provide a hot dog sample of 3 inches of length.

The hot dog sample is positioned so that the knife blade cuts transversely through the hot dog roughly midway along its length.

The Texture Analyzer Apparatus is fitted with a probe that is a TA-7 Knife Fixture, Warner-Bratzler Knife.

Texture Analyzer Apparatus instrument parameters are set as follows:

| Pre-test speed | 1.00 | mm/sec |
|---|---|---|
| Test speed | 5.00 | mm/sec |
| Post-test speed | 10.00 | mm/sec |
| Target, distance | 40 | mm |
| Time | 5 | sec |
| Trigger | Auto (Force) | |
| Trigger force | 5.0 | g |

This is referred to herein as the “Cold Hot Dog Product Firmness Test.” The cutting force is recorded, in grams of force, as the cutting firmness of the cold hot dog.

### Heated Hot Dog Product Firmness Test

A non-encased plant-based hot dog product is prepared and held overnight in a refrigerator. The cold hot dog product is prepared for testing by trimming ends to provide a hot dog sample of 3 inches of length, and the sample is heated to a temperature of 165 F by microwave. The hot dog sample is positioned so that the knife blade cuts transversely through the hot dog roughly midway along its length.

The Texture Analyzer Apparatus is fitted with a probe that is a TA-7 Knife Fixture, Warner-Bratzler Knife.

Texture Analyzer Apparatus instrument parameters are set as follows:

| Pre-test speed | 1.00 | mm/sec |
|---|---|---|
| Test speed | 5.00 | mm/sec |
| Post-test speed | 10.00 | mm/sec |
| Target, distance | 40 | mm |
| Time | 5 | sec |
| Trigger | Auto (Force) | |
| Trigger force | 5.0 | g |

This is referred to herein as the “Heated Hot Dog Product Firmness Test.” The cutting force is recorded, in grams of force, as the cutting firmness of the heated hot dog.

### Sensory Evaluation

Assays were carried out to characterize the sensory attributes of hot dogs that had been reheated to 165° F. Sensory attributes of the hot dogs were tested by a panel of at least three individuals that have experience in tasting and chewing plant-based meat alternatives. The panelists used a roundtable methodology to assess texture-firmness via touch, firmness in mouthfeel, and moistness in mouthfeel. To test each hot dog, the hot dog was divided into pieces and each of the panelists were given one piece. The panelists were able to cleanse their palates with water between hot dogs. Each panelist took a bite of the piece of the hot dog, chewed it, and agreed on a consensus assessment of each aspect of texture. For the second and subsequent hot dog samples, they agreed on a consensus assessment of the hot dog's texture relative to the previous hot dog formulation(s).

### EXAMPLES

### Example 1, Comparative

The components as set forth in Table 1 are used to prepare a plant based hot dog product:

TABLE 1

| Ingredient | Wt % |
|---|---|
| Water | 65.6% |
| Hot Dog Seasoning | 1.6% |
| Vinegar | 1.0% |
| Konjac Gum | 0.5% |
| Pea Protein Isolate | 10% |
| Salt | 1.5% |
| Modified Food Starch (Polartex 05732) | 1% |
| Inhibitor | 0.5% |
| Carrageenan (Satiagel RPI 740) | 1% |
| Methylcellulose | 1.8% |
| Canola Oil | 7.5% |
| Coconut Oil | 7.5% |
| Color | 0.5% |

### Directions:

Hydrate pea protein in food processor or bowl chopper with chilled water (<40° F.) at low speed until fully hydrated. Add oil and continue to mix until homogenous. Add methylcellulose and hydrate at low speed until fully dispersed. Add other hydrocolloids (konjac and carrageenan) and mix until hydrated. Finally, add remaining ingredients and mix until fully homogenized. Vacuum package to remove any incorporated air and refrigerate for up to 24 hours prior to stuffing in cellulose casings. Cook in combination oven at 325° F. and 100% steam until hot dogs reach an internal temperature of 170° F. Cool for 24 hours, then strip casings. Reheat to 165° F. for optimal consumption temperature and evaluate sensory aspects of the reheated hot dog.

### Results and Discussion:

The process as described in this example prioritizes hydration of the plant protein component over other hydrocolloids. After cooking, the ingredients form a set gel that allows the resulting hot dog product to hold its shape under cold and heated conditions, but is softer and dryer in texture than a traditional meat-based hot dog. Although the exterior of the resulting hot dog product feels firm to the touch after heating, it has a slightly mushy texture when bitten into. The average cutting force measured for these hot dog products using Heated Hot Dog Product Firmness Test is about 350 grams of force.

### Example 2, Comparative

The components as set forth in Table 2 are used to prepare a plant based hot dog product:

TABLE 2

| Ingredient | Wt % |
|---|---|
| Water (for methylcellulose) | 32.8% |
| Water (for pea protein) | 32.8% |
| Hot Dog Seasoning | 1.6% |
| Vinegar | 1.0% |
| Konjac Gum | 0.5% |
| Pea Protein Isolate | 10% |
| Salt | 1.5% |
| Modified Food Starch (Polartex 05732) | 1% |
| Inhibitor | 0.5% |
| Carrageenan (Satiagel RPI 740) | 1% |
| Methylcellulose | 1.8% |
| Canola Oil | 7.5% |
| Coconut Oil | 7.5% |
| Color | 0.5% |

### Directions:

Disperse methylcellulose and modified food starch in oil in food processor or bowl chopper and slowly add chilled water for methylcellulose (<40° F.) until fluffy white foam forms. Dry blend remaining dry ingredients until powders are well-mixed. Add blended dry ingredients to water for pea protein in paddle blender and continue to mix until dough forms. Add this protein dough to the methylcellulose emulsion in food processor or bowl chopper and chop until well-combined. Vacuum package to remove any incorporated air and refrigerate for up to 24 hours prior to stuffing in cellulose casings. Cook in combination oven at 325° F. and 100% steam until hot dogs reach an internal temperature of 170° F. Cool for 24 hours, then strip casings. Reheat to 165° F. for optimal consumption temperature and have the sensory panelists evaluate texture aspects of the reheated hot dog.

### Results and Discussion:

In this example, the plant-based hot dog was made by hydrating the methylcellulose separately from the pea protein and other dry ingredients. The plant-based hot dog made in accordance with this example was also able to hold its shape under both heated and cooled conditions after cooking. There were some improvements to the consistency of the emulsification as compared to Comparative Example 1. However, the plant-based hot dog when hot (“hot texture”) when bitten into was still mushy compared to a traditional meat hot dog. The average cutting force measured for these hot dog products using Heated Hot Dog Product Firmness Test is about 430 grams of force.

### Example 3

Obtain Field Roast Meat & Cheese Co. brand Classic Smoked Plant-Based Frankfurters at a local supermarket. Reheat the hot dogs to 165° F. for optimal consumption temperature and have the sensory panelists evaluate texture aspects of the reheated hot dog. The ingredients statement on the package identified the ingredients as filtered water, vital wheat gluten, expeller pressed safflower oil, yeast extract (yeast, salt, sugar, natural flavor), organic expeller pressed palm fruit oil, barley malt extract, tomato paste, apple cider vinegar, paprika color, spices, sea salt, onions, wheat flour, garlic, natural smoke flavor, celery seed, paprika oleoresin (color).

### Results and Discussion:

These commercial hot dogs are an example of a conventional vital wheat gluten-based veggie hot dog. They held their shape before and after reheating. The hot dogs were medium-firm to the touch and very chewy. While not necessarily dry on initial bite, they lost their moisture quickly upon initial chew and did not have any fatty mouthfeel. The average cutting force measured for these hot dog products using Heated Hot Dog Product Firmness Test is about 760 grams of force.

### Example 4

The components as set forth in Table 3 are used to prepare a plant based hot dog product:

TABLE 3

| Ingredient | Wt % |
|---|---|
| Water | 65.6% |
| Hot Dog Seasoning | 1.6% |
| Vinegar | 1% |
| Konjac Gum | 0.5% |
| Pea Protein Isolate | 10% |
| Salt | 1.5% |
| Modified Food Starch (Polartex 05732) | 1% |
| Inhibitor | 0.5% |
| Carrageenan (Satiagel RPI 740) | 1% |
| Methylcellulose | 1.8% |
| Canola Oil | 7.5% |
| Coconut oil | 7.5% |
| Color | 0.5% |

### Directions:

Disperse methylcellulose and color in oil in food processor or bowl chopper. Add chilled water (<40° F.) and continue to chop until fluffy foam forms. Dry blend remaining dry ingredients and add dry blend to methylcellulose emulsion. Mix well until ingredients fully incorporated and no dry spots remain. Add vinegar and continue to blend. Add melted coconut oil and continue to blend until well homogenized. Vacuum package to remove any incorporated air and refrigerate for up to 24 hours prior to stuffing in cellulose casings. Cook in combination oven at 100% steam until hot dogs reach an internal temperature of 195° F. Cool for 24 hours, then strip casings. Reheat to 165° F. for optimal consumption temperature and evaluate sensory aspects of the reheated hot dog.

### Results and Discussion:

The plant-based hot dog in this example were made in accordance with aspects of the present disclosure. Compared to the hot dogs of Examples 1 and 2, these plant-based hot dogs had a much firmer hot bite texture and also provided an increased perception of juiciness. Compared to the conventional vital wheat gluten hot dogs of Example 3, these hot dogs didn't have the extended chewiness of the vital wheat gluten hot dog. These hot dogs were noticeably more juicy that those of Example 3 and had a desirable fatty mouthfeel that those of Example 3 lacked. The sensory panel agreed that these hot dogs were a much closer approximation to a traditional meat hot dog than those in Examples 1-3. The average cutting force measured for these hot dog products using Heated Hot Dog Product Firmness Test is about 785 grams of force.

The cutting force measured for these hot dogs made in accordance with aspects of the present disclosure is notably higher than that of the hot dogs in Examples 1 and 2 and is closer to the cutting force measured for a conventional meat-based hot dog, too. The cutting force for these hot dogs is on par with that measured for the vital wheat gluten hot dogs in Example 3, but the sensory panel found the hot dogs in Example 3 too chewy and lacking in juiciness and fattiness and rated the texture of the present hot dogs more meat-like than those of Example 3.

Thus, hot dogs of Example 4 made in accordance with aspects of the present disclosure delivered surprisingly superior results to those in Examples 1 and 2 despite similarities in formula, highlighting the surprising impact of the process on the resultant hot dog's performance. The sensory aspects of these hot dogs were also superior to those of the conventional gluten-based hot dogs of Example 3.

As used herein, the terms “about” or “approximately” mean within an acceptable range for the particular parameter specified as determined by one of ordinary skill in the art, which will depend in part on how the value is measured or determined, e.g., the limitations of the sample preparation and measurement system. Examples of such limitations include preparing the sample in a wet versus a dry environment, different instruments, variations in sample height, and differing requirements in signal-to-noise ratios.

All patents, patent applications (including provisional applications), and publications cited herein are incorporated by reference as if individually incorporated for all purposes. Unless otherwise indicated, all parts and percentages are by weight and all molecular weights are weight average molecular weights. The foregoing detailed description has been given for clarity of understanding only. No unnecessary limitations are to be understood therefrom. The invention is not limited to the exact details shown and described, for variations obvious to one skilled in the art will be included within the invention defined by the claims.

1. A process of preparing a plant-based hot dog product comprising dispersing methylcellulose in liquid plant-based oil to form a methylcellulose/oil liquid dispersion;
adding water at a temperature suitable for hydration of the methylcellulose to the methylcellulose/oil liquid dispersion and mixing to form a methylcellulose/oil/water emulsion;
adding dry ingredients comprising plant protein, natural gum, starch, and carrageenan to the methylcellulose/oil/water emulsion with mixing to form a dough;
applying vacuum to the dough to degas the dough;
dispensing the dough into a casing to form an encased uncooked hot dog;
cooking the encased uncooked hot to an internal temperature of at least about 185° F. to form an encased cooked hot dog;
chilling the encased cooked hot dog to an internal temperature of about 45° F. or less to provide a plant-based hot dog product.

2. The process of claim 1, wherein the formed dough is cooled to a temperature of from about 35° F. to about 50° F. prior to dispensing into the casing.

3. The process of claim 1, wherein after the chilling of the encased cooked hot dog, the casing is removed to form a non-encased plant-based hot dog product.

4. The process of claim 1, wherein the methylcellulose is selected from food grade methylcellulose yielding a viscosity of from about 37,500 to about 100,000 cP at 2% in water @20° C.

5. The process of claim 1, wherein the methylcellulose is present in the dough in an amount of from about 0.5 wt % to about 4 wt %.

6. The process of claim 1, wherein the plant-based oil is selected from the group consisting of avocado, canola, coconut, cocoa, corn, cottonseed, flax, olive, palm, palm kernel, peanut, rapeseed, safflower, soya, and sunflower and mixtures thereof.

7. The process of claim 1, wherein the oil is present in the dough in an amount of from about 5 wt % to about 25 wt %.

8. The process of claim 1, wherein the water is added to the methylcellulose/oil liquid dispersion in a methylcellulose:water ratio of from about 1:25 to about 1:40.

9. The process of claim 1, wherein the plant protein is selected from the group consisting of alfalfa, algal, bean, broad bean, chia, clover, pea, chickpea, cow pea, earth pea, sweet pea, pigeon pea, kidney bean, mung bean, navy bean, soy, legume, lentil, lupin, mesquite, cocoa, carob, nut, peanut, almond, potato, cereal, maize, rice, sorghum, millet, oat, buckwheat, fonio, quinoa, hemp, fungal, seaweed protein, and mixtures thereof.

10. The process of claim 1, wherein the plant protein is present in the dough in an amount of from about 5 wt % to about 25 wt %.

11. The process of claim 1, wherein the natural gum is selected from glucomannan, galactomannan, and mixtures thereof.

12. The process of claim 1, wherein the natural gum is selected from konjac gum, locust bean gum, or a mixture thereof.

13. The process of claim 1, wherein the natural gum is present in the dough in an amount of from about 0.1 wt % to about 3 wt %.

14. The process of claim 1, wherein a source of the starch is selected from the group consisting of maize starch, potato starch, sweet potato starch, wheat starch, rice starch, tapioca starch, sorghum starch, sago starch, and mixtures thereof; or wherein the starch is a modified starch and wherein a source of the starch is selected from the group consisting maize starch, potato starch, sweet potato starch, wheat starch, rice starch, tapioca starch, sorghum starch, sago starch, and mixtures thereof.

15. The process of claim 1, wherein the starch comprises a modified starch selected from a hydroxypropyl distarch phosphate, a n-OSA substituted dextrin, an acid thinned n-OSA substituted dextrin, a n-OSA substituted and oxidized starch, or mixtures thereof.

16. The process of claim 1, wherein the starch is present in the dough in an amount of from about 0.2 wt % to about 3 wt %.

17. (canceled)

18. The process of claim 1, wherein the carrageenan is present in the dough in an amount of from about 0.2 wt % to about 3 wt %.

19. (canceled)

20. The process of claim 1, wherein the plant-based hot dog product has a cutting firmness of from 400 to 1,100 grams of force when reheated to 165° F.

21. (canceled)

22. The process of claim 1, wherein the casing is permeable to water vapor, and the step of cooking the encased uncooked hot dog comprises cooking it in a steam oven.

23. (canceled)

24. A plant-based hot dog product made by the process of claim 1.
